(19) United States
(12) Patent Application Publication
(10) Pub. No.: US 2014/0354799 A1
(43) Pub. Date: Dec. 4, 2014

(54) PATTERN INSPECTION METHOD AND PATTERN INSPECTION APPARATUS

(71) Applicant: KABUSHIKI KAISHA TOSHIBA, Tokyo (JP)

(72) Inventors: Tomoko OJIMA, Tokyo (JP); Masafumi ASANO, Kanagawa-ken (JP)

(73) Assignee: KABUSHIKI KAISHA TOSHIBA, Tokyo (JP)

(21) Appl. No.: 13/967,812

(22) Filed: Aug. 15, 2013

(30) Foreign Application Priority Data
May 30, 2013 (JP) 2013-114046

(51) Int. Cl. G01N 21/95

(52) U.S. Cl. CPC G01N 21/9501
USPC 348/126

(57) ABSTRACT

According to one embodiment, a pattern inspection method includes acquiring a first image using a first condition by irradiating an electron beam onto a pattern to be inspected, acquiring a second image using a second condition by irradiating the electron beam onto the pattern, the second condition being different from the first condition, and judging the existence/absence of defects of the pattern by comparing the first image and the second image. A pattern inspection apparatus includes an electron source, a converging part, a stage, an image acquisition part, a controller and a judgment part. The controller is configured to perform a control to acquire a first image using a first condition and acquire a second image using a second condition different from the first condition. The judgment part is configured to judge the existence/absence of defects of the pattern by comparing the first and the second image.

### CROSS-REFERENCE TO RELATED APPLICATIONS

This application is based upon and claims the benefit of priority from Japanese Patent Application No. 2013-114046, filed on May 30, 2013; the entire contents of which are incorporated herein by reference.

### FIELD

Embodiments described herein relate generally to a pattern inspection method and pattern inspection apparatus.

### BACKGROUND

Pattern inspection methods to inspect the defects of a pattern formed in a semiconductor wafer, etc., include a method using ultraviolet light or far ultraviolet light. In such a pattern inspection method, the ultraviolet light or far ultraviolet light is irradiated onto the pattern to be inspected; and the defects are judged from an image obtained by acquiring reflected light of the light irradiated onto the pattern. As the pattern is downscaled, it also may be considered to use a pattern inspection method using an electron beam from a scanning electron microscope, etc. However, in the pattern inspection method using the electron beam, much time is necessary to perform the inspection of a wide region. In the pattern inspection method and the pattern inspection apparatus, it is desirable to inspect a wide region in a short period of time.

### BRIEF DESCRIPTION OF THE DRAWINGS

FIG. 1 is a flowchart showing a pattern inspection method according to a first embodiment;

FIG. 2A and FIG. 2B are schematic views showing an example of a pattern to be inspected;

FIG. 3A and FIG. 3B are schematic plan views showing specific examples of the first image and the second image;

FIG. 4A and FIG. 4B are schematic plan views in which portions of the first image and the second image are enlarged;

FIG. 5 shows the signals of the images;

FIG. 6A and FIG. 6B are schematic plan views showing specific examples of the first image and the second image;

FIG. 7 is a schematic plan view showing a specific example of a binary image;

FIG. 8A to FIG. 8C are schematic views showing examples of images;

FIG. 9 is a schematic view showing the movement of an electron;

FIG. 10 is a schematic view showing spherical aberration;

FIG. 11 is a schematic view showing comatic aberration;

FIG. 12 is a schematic view showing astigmatic aberration;

FIG. 13 is a schematic view showing field curvature aberration;

FIG. 14 is a schematic view showing distortion aberration;

FIG. 15 is a schematic view showing chromatic aberration; and

FIG. 16 is a schematic view showing a pattern inspection apparatus according to a second embodiment.

### DETAILED DESCRIPTION

In general, according to one embodiment, a pattern inspection method includes acquiring a first image using a first condition by irradiating an electron beam onto a pattern to be inspected, acquiring a second image using a second condition by irradiating the electron beam onto the pattern, the second condition being different from the first condition, and judging the existence/absence of defects of the pattern by comparing the first image and the second image.

Various embodiments will now be described hereinafter with reference to the accompanying drawings. In the description hereinbelow, similar members are marked with like reference numerals, and a description is omitted as appropriate for members once described.

### First Embodiment

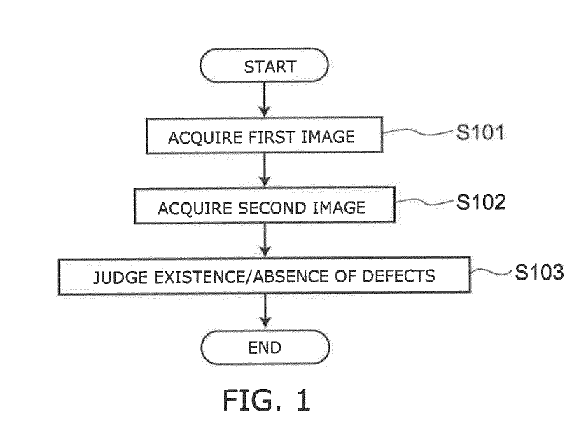

FIG. 1 is a flowchart showing a pattern inspection method according to a first embodiment.

As shown in FIG. 1, the pattern inspection method according to the embodiment includes acquiring a first image (step S101), acquiring a second image (step S102), and judging the existence/absence of defects (step S103).

The pattern inspection method according to the embodiment is a method for judging the existence/absence of defects of the pattern based on an image obtained by irradiating an electron beam onto the pattern to be inspected. Specifically, the pattern inspection method according to the embodiment acquires the image of the pattern using, for example, a scanning electron microscope and judges the existence/absence of defects of the pattern from the image that is acquired.

In the acquisition of the first image shown in step S101, the first image is acquired using a first condition by irradiating the electron beam onto the pattern to be inspected. In the case where the scanning electron microscope is used, the first image includes an image based on secondary electrons emitted from the pattern to be inspected.

The first condition includes at least one selected from a first focal distance of the electron beam, a first spot diameter of the electron beam on the pattern, and a first aberration applied to the electron beam.

In the acquisition of the second image shown in step S102, the second image is acquired using the second condition by irradiating the electron beam onto the pattern to be inspected. In the case where the scanning electron microscope is used, the second image includes an image based on secondary electrons emitted from the pattern to be inspected.

The second condition includes at least one selected from a second focal distance of the electron beam, a second spot diameter of the electron beam on the pattern, and a second aberration applied to the electron beam. The second condition is different from the first condition. The second image is an image acquired using a condition (the second condition) that is different from the first condition used when acquiring the first image.

In the judgment of the existence/absence of defects shown in step S103, the existence/absence of defects of the pattern is judged by comparing the first image acquired in step S101 to the second image acquired in step S102. For example, the difference between the signal of the first image and the signal of the second image is calculated; and the existence/absence of defects of the pattern and the locations of the defects are determined based on the calculation result.

In the case where the existence/absence of defects of the pattern is judged from the image acquired using the scanning electron microscope, the conditions for imaging such as the irradiation conditions of the electron beam, etc., are set to acquire the image having the highest definition. The image of a fine pattern on the order of about ten and several nanometers is obtained using the electron beam. On the other hand, much time is necessary to acquire and judge the image in the case where a wide region is to be inspected.

In the embodiment, the time to judge the defects is reduced by comparing the first image acquired using the first condition to the second image acquired using the second condition. Thereby, in the embodiment, the pattern inspection is performed for a wide region in a short period of time.

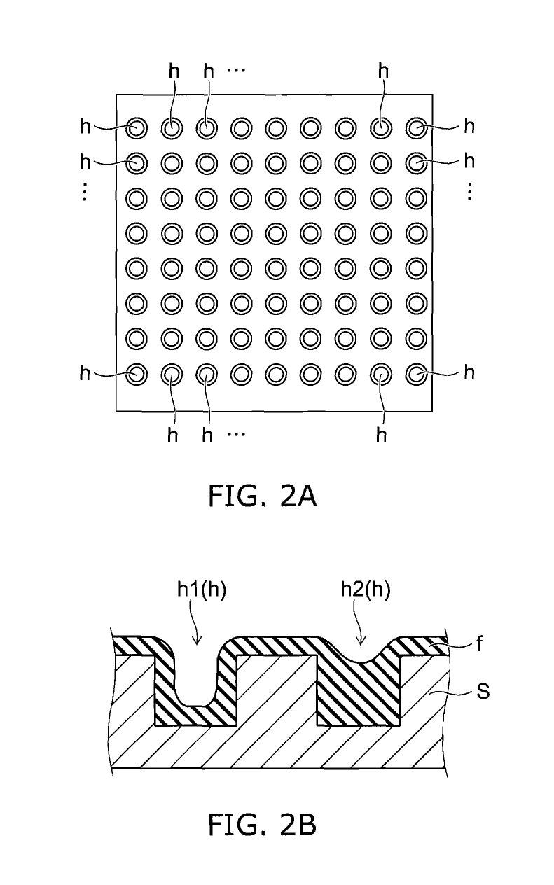

FIGS. 2A and 2B are schematic views showing an example of a pattern to be inspected.

FIG. 2A is a schematic plan view of the pattern to be inspected. FIG. 2B is a schematic cross-sectional view of the pattern to be inspected. FIG. 2B is a schematic cross-sectional view in which a portion of the pattern shown in FIG. 2A is enlarged.

As shown in FIGS. 2A and 2B, the pattern to be inspected is, for example, a pattern of a film f covering a recess h. The recess h is provided in a substrate S. The inner diameter of the recess h is, for example, 25 nanometers (nm). The material of the film f is, for example, a resin. The film f is formed to cover the surface of the substrate S and the inner surface of the recess h.

As shown in FIG. 2A, for example, the recess h is multiply provided in the substrate S. The multiple recesses h have, for example, a lengthwise and crosswise layout. As shown in FIG. 2B, the film f is formed along the inner surfaces of the recesses h.

Here, at a recess h1, which is one of the two recesses h shown in FIG. 2B, the film f is formed along the inner surface of the recess h1. On the other hand, the thickness of the film f is thicker at a recess h2, which is the other of the two recesses h shown in FIG. 2B, than at the recess h1. Fluctuation occurs in the thickness of the film f covering the inner surfaces of the recesses h. The thickness of the film f is acceptable if within a specified range and unacceptable if outside the specification.

The states of acceptable/unacceptable of the pattern shown in FIG. 2B are an example. In the embodiment, other than the thickness of the film f, various states of the pattern such as the diameter of the recess h, the existence/absence of the recess h, etc., may be inspected.

A first specific example of the pattern inspection method according to the embodiment will now be described.

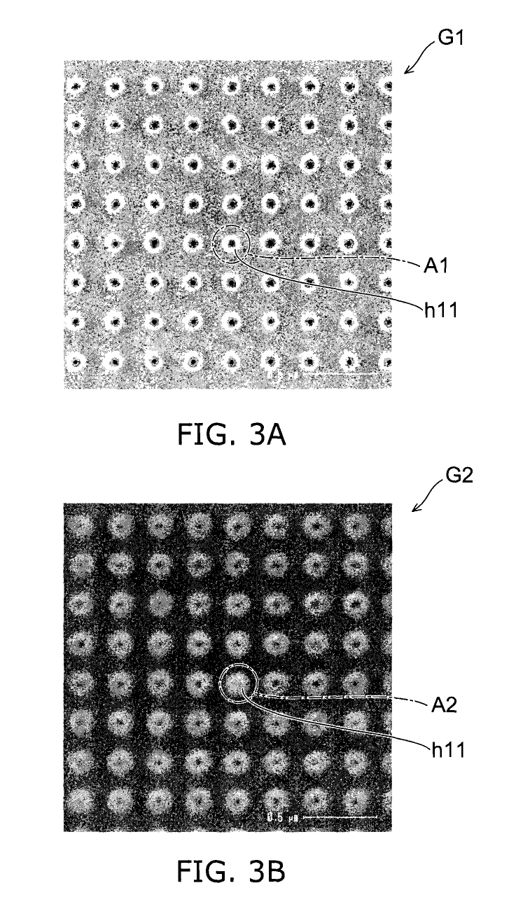

FIGS. 3A and 3B are schematic plan views showing specific examples of the first image and the second image.

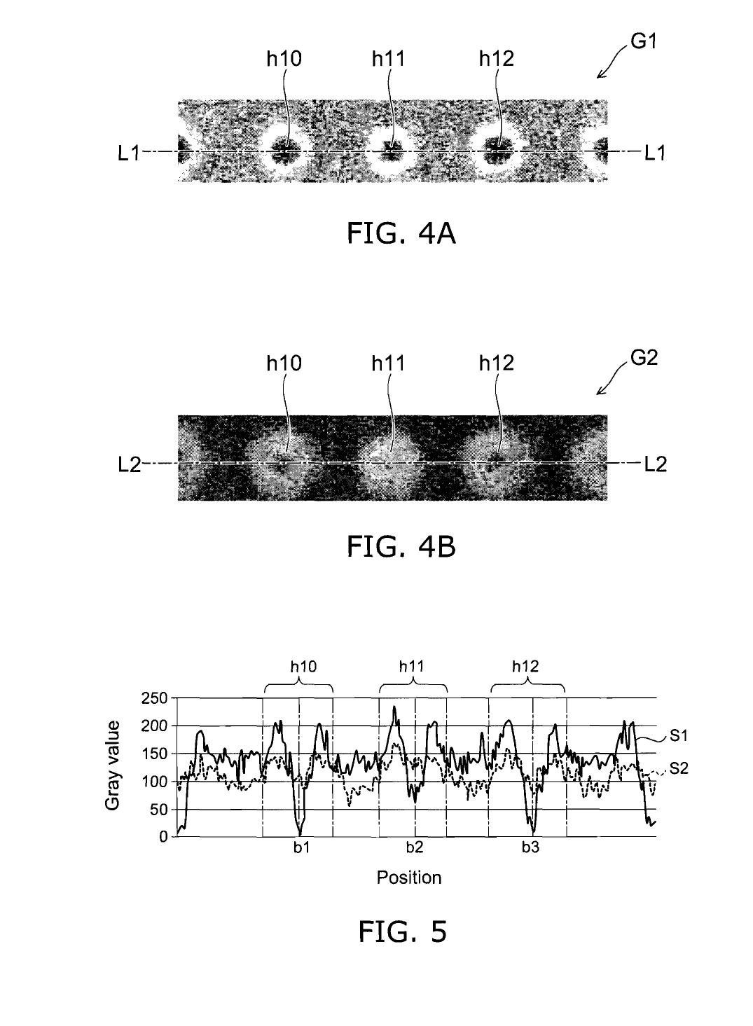

FIGS. 4A and 4B are schematic plan views in which portions of the first image and the second image are enlarged.

FIG. 3A to FIG. 4B show examples of images of the pattern shown in FIGS. 2A and 2B.

First, a first image G1 such as that shown in FIG. 3A is acquired using the first condition. The first condition is, for example, a condition (the acceleration voltage, the beam spot, the beam configuration, the focal distance, etc.) at which the image can be acquired accurately. In the first image G1 shown in FIG. 3A, the portion of the film f provided in the inner surface of the recess h is displayed as being whiter than the other portions. Also, the portion of the bottom of the recess h is displayed as being blacker than the portion of the film f. In other words, the film f appears to have a ring configuration in the first image G1.

Then, a second image G2 such as that shown in FIG. 3B is acquired using the second condition. The second condition includes a second focal distance that is different from the first focal distance included in the first condition. Accordingly, in the second image G2 shown in FIG. 3B, the definition of the image of the ring configuration of the film f is lower than that of the first image G1.

Images of a recess h11 shown in portion A1 of FIG. 3A and portion A2 of FIG. 3B will now be focused upon. FIG. 4A shows an enlarged image of the first image G1 including the recess h11. As shown in FIG. 4A, the image of the film f of the recess h11 of the first image G1 appears to have a ring configuration. Also, the images of the film f of recesses h10 and h12 that are proximal to the recess h11 appear to have ring configurations.

FIG. 4B shows an enlarged image of the second image G2 including the recess h11. In the second image G2 shown in FIG. 4B, the brightness of the central portions of the recesses h10, h11, and h12 is brighter than in the first image G1 shown in FIG. 4A. On the other hand, the image of the film f is darker.

Here, in the second image G2 as shown in FIG. 4B, the image of the film f of the recess h11 appears not to have a ring configuration but to have a circular configuration. On the other hand, the images of the film f of the recesses h10 and h12 that are proximal to the recess h11 appear to have ring configurations. In other words, a distinct difference appears in the image of the recess h11 between the first image G1 acquired using the first focal distance and the second image G2 acquired using the second focal distance.

In the embodiment, by comparing the first image G1 and the second image G2, it is judged that the portion where the distinct difference appears in the images is a defect.

FIG. 5 shows the signals of the images.

FIG. 5 shows a first signal waveform S1 and a second signal waveform S2. The first signal waveform S1 illustrates the signal level of the first image G1 along line L1-L1 of FIG. 4A. The second signal waveform S2 illustrates the signal level of the second image G2 along line L2-L2 of FIG. 4B. In FIG. 5, the horizontal axis is the position; and the vertical axis is the signal level (a relative value of the grayscale intensity).

The difference between high and low signal levels is larger in the first signal waveform S1 than in the second signal waveform S2. In the embodiment, the positions of the recesses h10, h11, and h12 are sensed from, for example, the change of the first signal waveform S1. Then, the existence/absence of defects of the pattern is judged from the signal levels of the first signal waveform S1 and the second signal waveform S2 and the change of the signal levels.

Specifically, first, the positions of the recesses h10, h11, and h12 and positions b10, b11, and b12 of the signal bottoms of the recesses h10, h1, and h12 are sensed from the first signal waveform S1. Then, the difference between the first signal waveform S1 and the second signal waveform S2 and the signal level of the second signal waveform S2 at the positions b10, b11, and b12 of the signal bottoms are determined.

Continuing, it is determined whether or not the difference between the first signal waveform S1 and the second signal waveform S2 and/or the signal level of the second signal waveform S2 at the positions b10, b11, and b12 of the signal bottoms exceed a pre-set threshold. It is judged whether or not there are defects in the pattern based on the determination.

For example, in the example shown in FIG. 5, it is determined whether or not the signal level of the second signal waveform S2 at the positions b10, b11, and b12 of the signal bottoms exceeds a pre-set threshold (e.g., 100). For the positions b10, b11, and b12 of the signal bottoms, the signal level exceeds the threshold at the position b11. The signal level does not exceed the threshold at the positions b10 and b12. Accordingly, it is judged that the pattern of the recess h11 corresponding to the position b11 is a defect.

The judgment of the defects using the signal level such as that recited above is but an example; and other judgment methods that use the difference between the signal level of the first signal waveform S1 and the signal level of the second signal waveform S2, etc., may be used.

The judgment of the defects of the pattern is easier in the pattern inspection method according to the embodiment than in the case where the defects of the pattern are judged from only the first image G1 because the existence/absence of defects of the pattern is judged by comparing two images having different conditions. Accordingly, the defects of the pattern can be judged in a short period of time.

In the pattern inspection method according to the embodiment, it is desirable for the amount of information of the second image G2 to be less than the amount of information of the first image G1. By setting the amount of information of the second image G2 to be less than the amount of information of the first image G1, the processing to judge the defects of the pattern from the signals of the images is easier.

A second specific example of the pattern inspection method according to the embodiment will now be described.

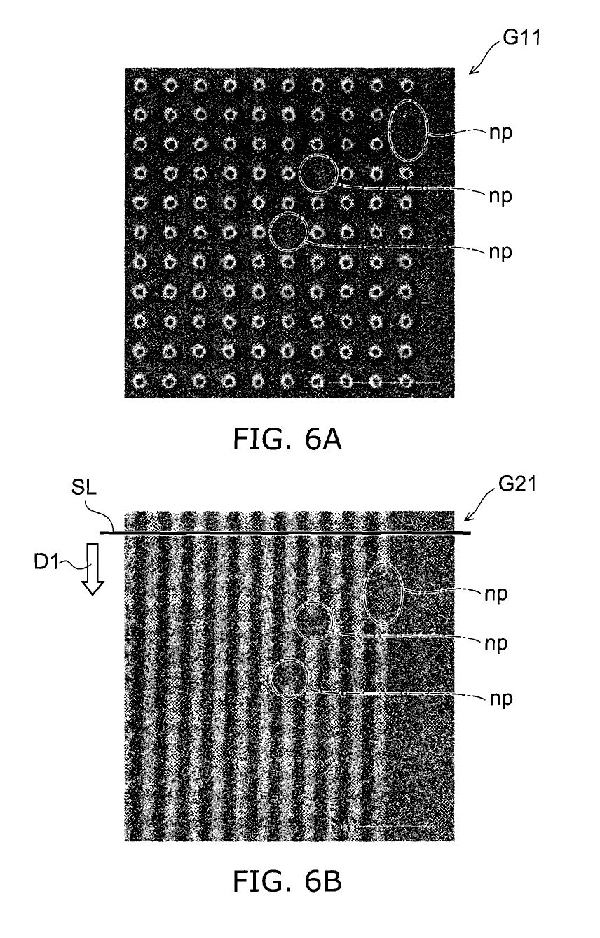

FIGS. 6A and 6B are schematic plan views showing specific examples of the first image and the second image.

FIGS. 6A and 6B show examples of images of the pattern shown in FIGS. 2A and 2B.

First, a first image G11 such as that shown in FIG. 6A is acquired using the first condition. The first condition is, for example, a condition (the acceleration voltage, the beam spot, the beam configuration, the focal distance, etc.) at which the image can be acquired accurately. In the first image G1 shown in FIG. 3A, the portion of the film f provided in the inner surface of the recess h is displayed as being whiter than the other portions. Also, the portion of the bottom of the recess h is displayed as being blacker than the portion of the film f. In other words, the film f appears to have a ring configuration in the first image G1. Here, the image of a portion np where the recess h is not formed also is displayed in the first image G11.

Then, a second image G21 such as that shown in FIG. 6B is acquired using the second condition. The second condition includes a condition such that the image of the recess h is elongated in one direction compared to the image of the first image G1. For example, the second condition includes a condition in which a strong astigmatic aberration compared to the first condition is applied to the electron beam. Thereby, the images of the multiple recesses h that are arranged in the one direction appear as a line configuration in the one direction in the second image G21. That is, by applying the astigmatic aberration such that the images are elongated in the one direction, the images of the multiple recesses h that are adjacent to each other in the one direction appear to be linked in a line configuration.

Here, in the second image G21, the image of the portion np where the recess h is not made is not linked to the images of the recesses h elongated in the one direction. In the pattern inspection method according to the embodiment, the portion where the images having the line configuration are discontinuous is judged to be a location where there is a defect of the pattern based on such a second image G21.

To judge the existence/absence of defects of the pattern from the second image G21, for example, the signal level along a sensing line SL in a direction orthogonal to a direction (a first direction D1) in which the images of the second image G21 are elongated in the line configuration is sensed. Then, the sensing line SL is scanned in the first direction D1; and a location is judged to be a location where there is a defect of the pattern if the sensed signal level decreases at the location.

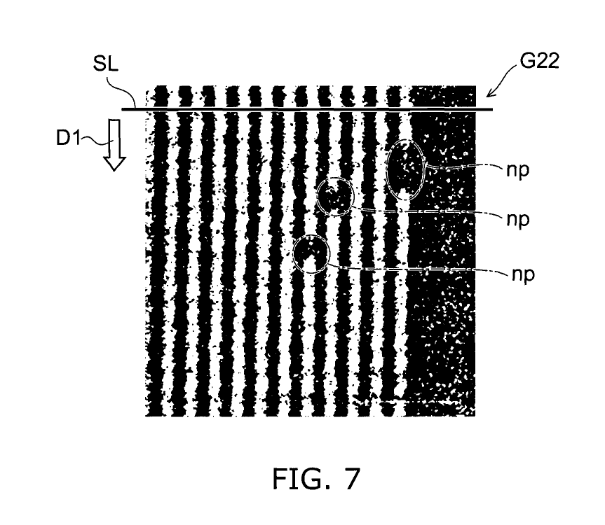

FIG. 7 is a schematic plan view showing a specific example of a binary image.

In the second specific example as shown in FIG. 7, an image G22, which is the second image G21 binarized using a prescribed threshold, may be used. To judge the existence/absence of defects of the pattern, the signal level along the sensing line SL of the binarized image G22 is sensed. Then, the sensing line SL is scanned in the first direction D1; and the change of the signal level is read. By using the binarized image G22, the change of the signal level is greater than in the case where the image G21 is used. Accordingly, the existence/absence of defects is judged easily.

A third specific example of the pattern inspection method according to the embodiment will now be described.

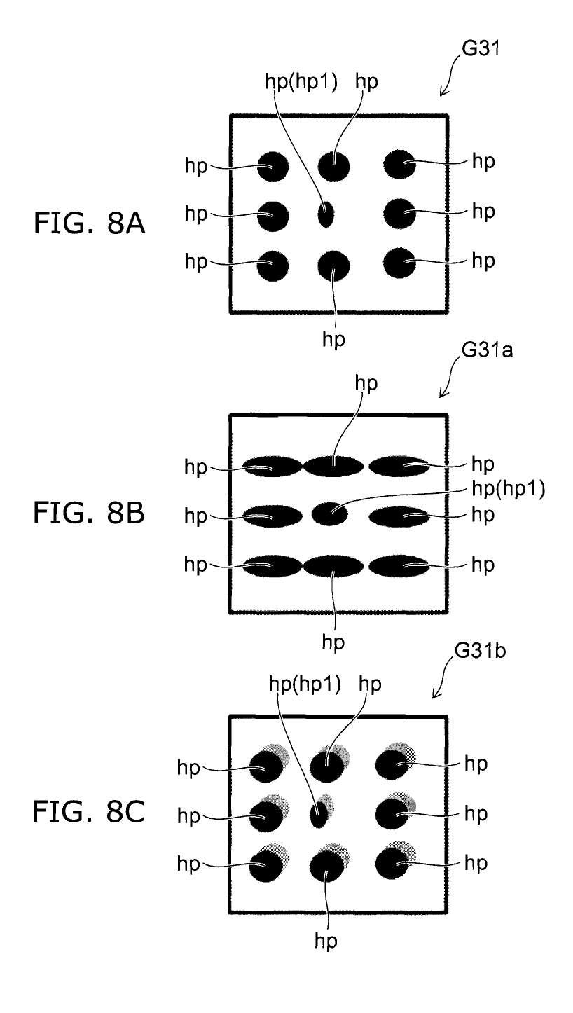

FIGS. 8A to 8C are schematic views showing examples of images.

FIG. 8A shows an image G31 of a hole pattern. FIG. 8B shows an image G32a of the hole pattern. FIG. 8C shows an image G32b of the hole pattern.

The image G31 shown in FIG. 8A is the first image acquired using the first condition. Images of the multiple hole patterns hp appear in the image G31. The multiple hole patterns hp are disposed lengthwise and crosswise. A hole pattern hp1 which is one of the multiple hole patterns hp includes a defect.

The image G32a shown in FIG. 8B is the second image acquired using the second condition (#1). The second condition (#1) includes a condition in which a strong astigmatic aberration compared to the first condition is applied to the electron beam. In the example shown in FIG. 88B, the astigmatic aberration is applied as the second condition (#1) such that the images of the hole patterns hp are elongated in the one direction.

The image G32b shown in FIG. 8C is the second image acquired using the second condition (#2). The second condition (#2) includes a condition in which, compared to the first condition, a spherical aberration is applied to the electron beam. In the example shown in FIG. 8C, the spherical aberration is applied as the second condition (#2) such that the images of the hole patterns hp are elongated to expand in an oblique direction.

In the third specific example, the existence/absence of defects of the pattern is judged using at least two selected from the images G31, G32a, and G32b. For example, in the case where it is difficult to judge the existence/absence of defects using only the image G31, the locations of the defects can be enhanced by using the image G32a and/or the image G32b; and the existence/absence of defects can be judged easily.

For the first condition and the second condition in the pattern inspection method according to the embodiment, the condition to acquire the image is modified by adjusting the aberration applied to the electron beam, the focal distance of the electron beam, the emission energy (the acceleration voltage, etc.) of the irradiated electrons, the positional relationship between the convergence position of the electron beam and the sample (the pattern to be inspected), etc. The aberration applied to the electron beam and the focal distance of the electron beam are adjusted by adjusting the electromagnetic lens that converges the electron beam. Then, the existence/absence of defects of the pattern is judged in a short period of time based on the images acquired using the different conditions.

The movement of the electrons irradiated onto the pattern to be inspected will now be described.

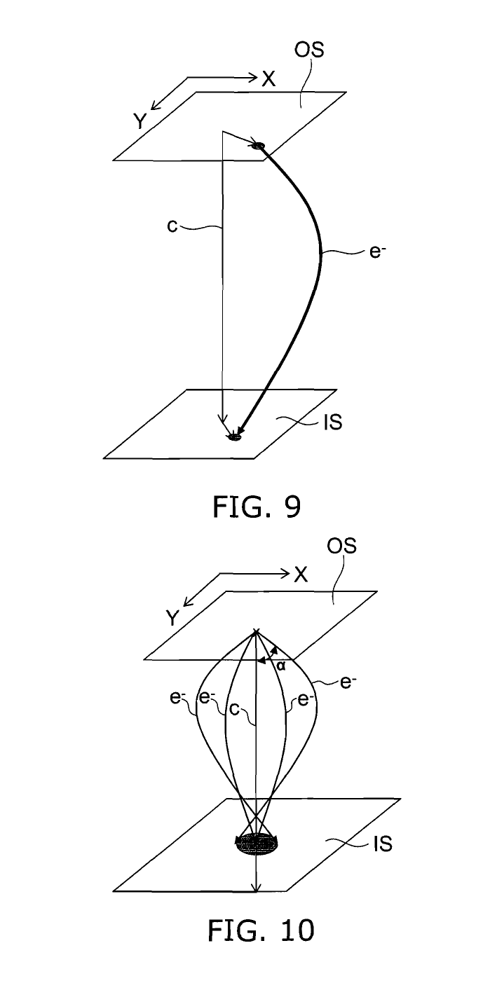

FIG. 9 is a schematic view showing the movement of an electron.

FIG. 9 schematically shows the movement of the electron e⁻ from an object surface OS toward an image surface IS. The movement of the electron e⁻ inside a vacuum is determined by the equation of motion of Mathematical Formula 1.

$$m \frac{{d}^{2} \vec{r}}{d {t}^{2}} = - e [ \vec{E} + \vec{v} \times \vec{B} ] \qquad [ Mathematical Formula 1 ]$$

In Mathematical Formula 1, m is the mass of the electron e⁻, e is the elementary charge, E is the electric field, B is the magnetic field, r is the coordinate of the electron e⁻, and v is the velocity of the electron e⁻.

A position Uo of the electron e⁻ at the object surface OS centered on an optical axis c of the electromagnetic lens is Uo=Xo+jYo; and a position Ui of the electron e⁻ at the image surface IS is Ui=Xi+jYi. Here, the movement of the electron e⁻ is taken to be in a rotationally symmetric system centered on the optical axis c of the electromagnetic lens. Two axes along a surface orthogonal to the optical axis c are taken as an X axis and a Y axis. Xo is the position on the X axis along the object surface OS; and Yo is the position on the Y axis along the object surface OS. Xi is the position on the X axis along the image surface IS; and Yi is the position on the Y axis along the image surface IS. It is taken that there is no temporal fluctuation of the magnetic field that is generated by the electromagnetic lens. In such a case, the trajectory of the electron e⁻ from the object surface OS to the image surface IS is represented by a power polynomial expansion. In the power polynomial expansion (referring to Mathematical Formula 2), the perfect imaging trajectory (the paraxial trajectory) is represented by the linear terms; and the geometric aberration is represented by the cubic terms.

ΔU⁽³⁾/M=AUᵢ²Ūᵢ+BUᵢ²Ū₀+CUᵢŪᵢU₀+DŪᵢU₀²+EUᵢU₀Ū₀+FU₀²Ū₀ [Mathematical Formula 2]

FIG. 10 is a schematic view showing spherical aberration.

The spherical aberration shown in FIG. 10 is represented by coefficient A of Mathematical Formula 2. The spherical aberration is a component (emitted from the origin) that does not depend on the position Uo of the electron e⁻ of the object surface OS shown in FIG. 9.

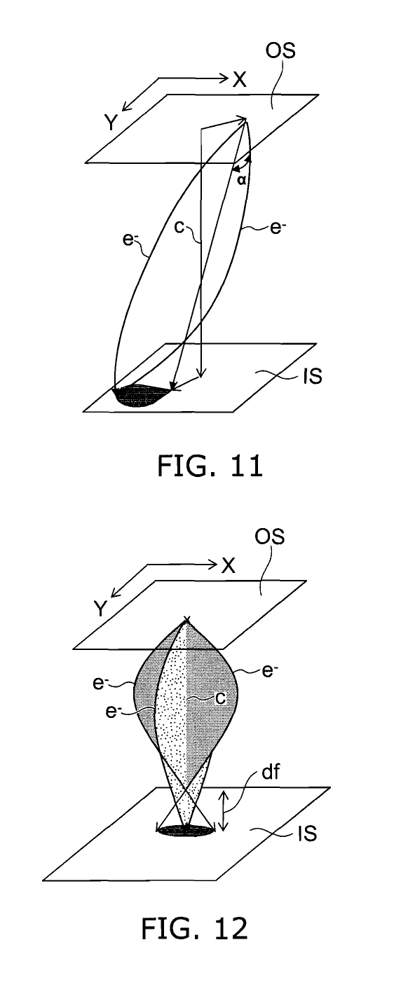

FIG. 11 is a schematic view showing comatic aberration.

The comatic aberration shown in FIG. 11 is represented by coefficients B and C of Mathematical Formula 2. The comatic aberration is a component that depends on the linear components of the position Uo of the electron e⁻ of the object surface OS shown in FIG. 9.

FIG. 12 is a schematic view showing astigmatic aberration.

The astigmatic aberration shown in FIG. 12 is represented by coefficients D and E of Mathematical Formula 2. The astigmatic aberration is a component that depends on the quadratic components of the position Uo of the electron e⁻ of the object surface OS shown in FIG. 9. In the astigmatic aberration, the focal position differs (the astigmatic separation df) according to the emission direction of the electron e⁻.

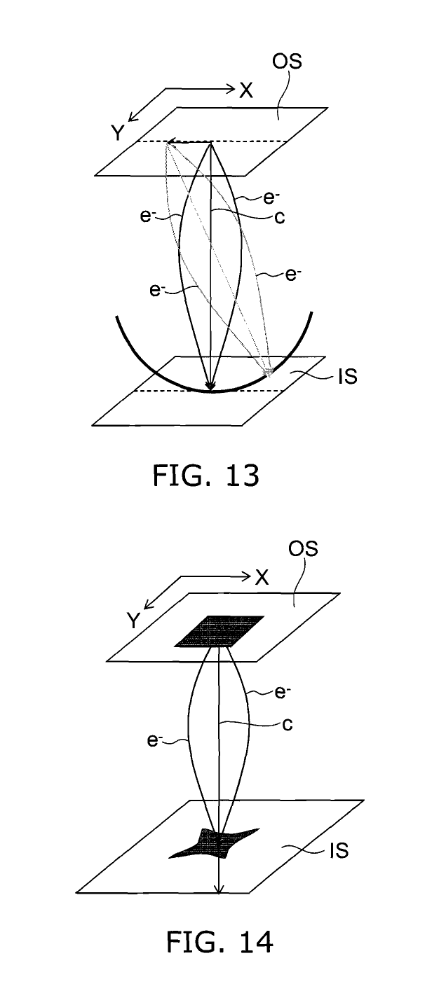

FIG. 13 is a schematic view showing field curvature aberration.

The field curvature aberration shown in FIG. 13 is represented by coefficients D and E of Mathematical Formula 2. The field curvature aberration is a component that depends on the quadratic components of the position Uo of the electron e⁻ of the object surface OS shown in FIG. 9. In the field curvature aberration, the focal surface of the electron e⁻ is curved.

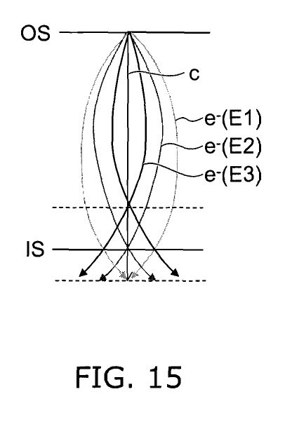

FIG. 14 is a schematic view showing distortion aberration.

The distortion aberration shown in FIG. 14 is represented by coefficient F of Mathematical Formula 2. The distortion aberration is a component that does not depend on the position Ui of the electron e⁻ of the image surface IS shown in FIG. 9. In the distortion aberration, distortion of the image of the electron e⁻ at the image surface IS occurs.

FIG. 15 is a schematic view showing chromatic aberration.

In the chromatic aberration shown in FIG. 15, the focal position shifts due to differences of the incident energy of the electron e⁻ into the electromagnetic lens. In the example shown in FIG. 15, the incident energy of the electron e⁻ (E1) is higher than the incident energy of the electron e⁻ (E2). The incident energy of the electron e⁻ (E2) is higher than the incident energy of the electron e⁻ (E3). The focal position is more distal to the object surface OS as the incident energy increases.

In the pattern inspection method according to the embodiment, the geometric aberrations based on the coefficients of the cubic terms of Mathematical Formula 2 are deliberately produced by adjusting the electromagnetic lens. Also, in the pattern inspection method according to the embodiment, the chromatic aberration is deliberately produced by adjusting the incident energy of the electrons into the electromagnetic lens. Thereby, the first image is acquired using the first condition; the second image is acquired using the second condition; and the existence/absence of defects of the pattern is judged based on the comparison of the first image and the second image.

According to the embodiment, the existence/absence of defects of the pattern can be judged in a short period of time by acquiring images in which it is easy to find the defects of the pattern by adjusting the electromagnetic lens and adjusting the energy of the electrons. Moreover, complex signal processing of the images is unnecessary because the defects of the pattern are judged by acquiring two images having different conditions and comparing the images. In the embodiment, even for a fine pattern, the defect inspection can be performed in a short period of time for a wide region.

### Second Embodiment

A second embodiment will now be described.

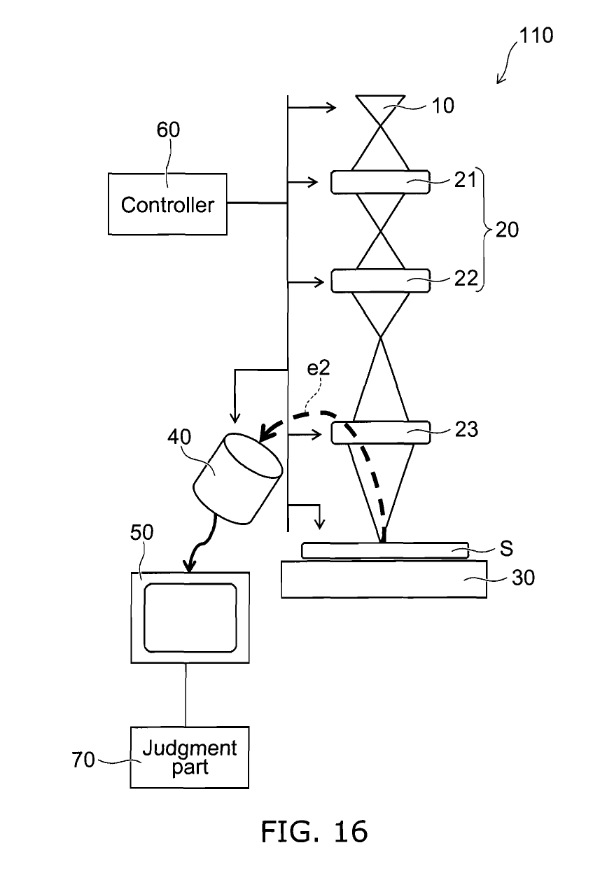

FIG. 16 is a schematic view showing a pattern inspection apparatus according to a second embodiment.

As shown in FIG. 16, the pattern inspection apparatus 110 includes an electron gun 10 which is an electron source, a converging part 20, a stage 30, a sensor 40 which is an image acquisition part, a controller 60, and a judgment part 70.

The electron gun 10 emits electrons. The converging part 20 causes an electron beam made of the electrons to converge. The converging part 20 includes an electromagnetic lens. The electromagnetic lens includes, for example, a condenser lens 21 and an objective lens 22. The condenser lens 21 is an electromagnetic lens that stops down the electron beam made of the electrons emitted from the electron gun 10. The objective lens 22 is an electromagnetic lens that forms an image at a prescribed position using the electron beam that is stopped down by the condenser lens 21.

The stage 30 is a table on which a sample (e.g., the substrate S) including the pattern to be inspected is placed. The stage 30 is movable in two axis directions along the placement surface of the sample. Also, the stage 30 is movable in a direction orthogonal to the placement surface of the sample.

The sensor 40 acquires a signal based on the electron beam irradiated onto the pattern. For example, the sensor 40 senses secondary electrons e2 emitted from the pattern by the electron beam irradiated onto the pattern.

The controller 60 controls the electron gun 10, the converging part 20, and the stage 30. For example, the controller 60 controls the acceleration of the electrons by controlling the acceleration voltage applied to the electron gun 10. Also, the controller 60 controls the aberration and/or the focal distance of the electron beam by controlling the voltage applied to the electromagnetic lens of the converging part 20. The controller 60 also controls the position of the stage 30.

The judgment part 70 judges the existence/absence of defects of the pattern from images based on the signal sensed by the sensor 40.

The pattern inspection apparatus 110 includes a scanning coil 23. The electron beam that passes through the objective lens 22 is scanned onto the sample by the scanning coil 23. A two-dimensional image is obtained by scanning the electron beam onto the surface of the sample.

The pattern inspection apparatus 110 may include a display part 50. The display part 50 displays images based on the signal sensed by the sensor 40. Also, the display part 50 may display the result of the existence/absence of defects of the pattern judged by the judgment part 70.

By the control of the controller 60 in the pattern inspection apparatus 110 according to the embodiment, the first image is acquired using the first condition; and the second image is acquired using the second condition. In other words, the controller 60 acquires the first image using the first condition by irradiating the electron beam onto the pattern on the stage 30 by controlling the electron gun 10, the converging part 20, the stage 30, etc. The first condition includes at least one selected from the first focal distance of the electron beam, the first spot diameter of the electron beam on the pattern, and the first aberration applied to the electron beam.

The controller 60 also acquires the second image using the second condition by irradiating the electron beam onto the pattern on the stage 30 by controlling the electron gun 10, the converging part 20, the stage 30, etc. The second condition is different from the first condition. The second condition includes at least one selected from the second focal distance of the electron beam, the second spot diameter of the electron beam on the pattern, and the second aberration applied to the electron beam.

The judgment part 70 judges the existence/absence of defects of the pattern by comparing the first image and the second image. In other words, the existence/absence of defects of the pattern is judged by comparing the first image and the second image acquired by the control of the controller 60. For example, the difference between the signal of the first image and the signal of the second image is calculated; and the existence/absence of defects of the pattern and the locations of the defects are determined based on the calculation result.

The pattern inspection apparatus 110 executes the pattern inspection method described above. For example, for the first condition and the second condition, the condition to acquire the image is modified by adjusting the aberration applied to the electron beam, the focal distance of the electron beam, the emission energy (the acceleration voltage, etc.) of the irradiated electrons, the positional relationship between the convergence position of the electron beam and the sample (the pattern to be inspected), etc.

In the case where the aberration is applied to the electron beam, the controller 60 controls the converging part 20. For example, in the case where the spherical aberration is applied, the controller 60 controls the voltage applied to at least one selected from the condenser lens 21 and the objective lens 22.

In the case where the comatic aberration is applied, the controller 60 controls, for example, the voltage applied to the objective lens 22. In the case where the astigmatic aberration is applied, the controller 60 controls, for example, the voltage applied to the objective lens 22. In the case where the field curvature aberration is applied, the controller 60 controls, for example, the voltage applied to the objective lens 22. In the case where the distortion aberration is applied, the controller 60 controls, for example, the voltage applied to the objective lens 22. In the case where the chromatic aberration is applied, the controller 60 controls, for example, the voltage applied to the condenser lens 21.

In the pattern inspection apparatus 110, the time to judge the defects is reduced by comparing the first image acquired using the first condition to the second image acquired using the second condition. Thereby, in the embodiment, the pattern inspection is performed for a wide region in a short period of time. Also, in the pattern inspection apparatus 110, the desired aberration can be easily obtained because the aberration is adjusted by the voltage applied to the electromagnetic lens of the converging part 20.

As described above, according to the pattern inspection method and the pattern inspection apparatus according to the embodiments, a wide region can be inspected in a short period of time.

Although the embodiments are described above, the invention is not limited to these examples. For example, although the existence/absence of defects of the pattern is judged in the embodiments recited above by acquiring the first image and the second image and comparing the images, the existence/absence of defects of the pattern may be judged by acquiring three or more images and by comparing at least two of the images. Multiple images having different conditions may be acquired continuously at a prescribed time interval; and the existence/absence of defects of the pattern may be judged by comparing at least two of the images. Further, additions, deletions, or design modifications of components or appropriate combinations of the features of the embodiments appropriately made by one skilled in the art in regard to the embodiments described above are within the scope of the invention to the extent that the spirit of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A pattern inspection method, comprising:
acquiring a first image using a first condition by irradiating an electron beam onto a pattern to be inspected;
acquiring a second image using a second condition by irradiating the electron beam onto the pattern, the second condition being different from the first condition; and
judging the existence/absence of defects of the pattern by comparing the first image and the second image.

2. The method according to claim 1, wherein
the first condition includes a first aberration applied to the electron beam, and
the second condition includes a second aberration applied to the electron beam.

3. The method according to claim 2, wherein
the first aberration includes at least one selected from spherical aberration, comatic aberration, astigmatic aberration, field curvature aberration, distortion aberration, and chromatic aberration, and
the second aberration includes at least one selected from spherical aberration, comatic aberration, astigmatic aberration, field curvature aberration, distortion aberration, and chromatic aberration.

4. The method according to claim 1, wherein
the first condition includes a first focal distance of the electron beam, and
the second condition includes a second focal distance of the electron beam.

5. The method according to claim 1, wherein
the first condition includes a first spot diameter of the electron beam on the pattern, and
the second condition includes a second spot diameter of the electron beam on the pattern.

6. The method according to claim 1, wherein the first image and the second image include images based on secondary electrons emitted from the pattern.

7. The method according to claim 1, wherein the amount of information of the second image is less than the amount of information of the first image.

8. The method according to claim 1, wherein the second condition is a condition to elongate an image configuration of the pattern of the second image in one direction in the case where the pattern has an island configuration.

9. A pattern inspection apparatus, comprising:
an electron source configured to emit electrons;
a converging part configured to cause an electron beam made of the electrons to converge;
a stage configured to have a sample placed on the stage, a pattern to be inspected being provided in the sample;
an image acquisition part configured to acquire a signal based on the electron beam irradiated onto the pattern;
a controller configured to control the electron source, the converging part, and the stage; and
a judgment part configured to judge the existence/absence of defects of the pattern from an image based on the signal acquired by the image acquisition part,
the controller being configured to perform a control to acquire a first image using a first condition and acquire a second image using a second condition different from the first condition,
the judgment part being configured to judge the existence/absence of defects of the pattern by comparing the first image and the second image.

10. The apparatus according to claim 9, wherein
the first condition includes a first aberration applied to the electron beam, and
the second condition includes a second aberration applied to the electron beam.

11. The apparatus according to claim 10, wherein
the first aberration includes at least one selected from spherical aberration, comatic aberration, astigmatic aberration, field curvature aberration, distortion aberration, and chromatic aberration, and
the second aberration includes at least one selected from spherical aberration, comatic aberration, astigmatic aberration, field curvature aberration, distortion aberration, and chromatic aberration.

12. The apparatus according to claim 9, wherein
the first condition includes a first focal distance of the electron beam, and
the second condition includes a second focal distance of the electron beam.

13. The apparatus according to claim 9, wherein
the first condition includes a first spot diameter of the electron beam on the pattern, and
the second condition includes a second spot diameter of the electron beam on the pattern.

14. The apparatus according to claim 9, wherein the first image and the second image include images based on secondary electrons emitted from the pattern.

15. The apparatus according to claim 9, wherein the amount of information of the second image is less than the amount of information of the first image.

16. The apparatus according to claim 9, wherein the second condition is a condition to elongate an image configuration of the pattern of the second image in one direction in the case where the pattern has an island configuration.
